(19) United States
(12) Patent Application Publication
(10) Pub. No.: US 2023/0291042 A1
(43) Pub. Date: Sep. 14, 2023

(54) BATTERY CELL SEAL, SEAL ASSEMBLY FOR BATTERY CELL, AND BATTERY CELL COMPRISING A CROSS-LINKED GROMMET

(71) Applicant: DURACELL U.S. OPERAITONS, INC., Wilmington, DE (US)

(72) Inventor: Alexander Shelekhin, Ridgefield, CT (US)

(73) Assignee: DURACELL U.S. OPERATIONS, INC., Wilmington, DE (US)

(21) Appl. No.: 17/691,030

(22) Filed: Mar. 9, 2022

(51) Int. Cl. H01M 50/184; H01M 50/193; H01M 4/66; H01M 10/04; C08L 77/02; C08J 3/24

(52) U.S. Cl. CPC H01M 50/184; H01M 50/193; H01M 4/662; H01M 10/04; C08L 77/02; C08J 3/24; C08J 2377/02

(57) ABSTRACT

A seal assembly for a battery cell comprises a cross-linked grommet having an opening. A current collector has a head and a stem extending from the head, the stem and the grommet forming an interference fit at the opening. The grommet comprises a cross-linked polymer. A method of manufacturing a battery cell with a cross-linked grommet comprises forming a grommet comprising a precursor polymer material, thereby forming a pre-formed grommet, exposing the pre-formed grommet comprising the precursor polymer material to a cross-linking treatment, thereby forming a cross-linked grommet, and incorporating the cross-linked grommet in a battery cell.

### FIELD OF THE DISCLOSURE

The disclosure relates to battery cells and more specifically to battery cell seals, seal assemblies for battery cells, and battery cells that include cross-linked grommets.

### BACKGROUND

Consumer electronic devices have certain power requirements. Generally, consumer electronic devices receive power from one or more battery cells (contained within the device itself), or from an external portable battery pack that may include one or more battery cells. For example, one or more single-use battery cells (commonly referred to as “primary batteries”) or one or more rechargeable battery cells (commonly referred to as “secondary batteries”) may be used and replaced in a device as needed. Battery cells generate electricity through reduction of a cathode and oxidation of an anode. An electrolyte is included to facilitate movement of ions from the anode to the cathode to balance the flow of electrons.

Alkaline battery cells (including rechargeable alkaline battery cells) are known to be susceptible to the leakage of alkaline electrolytes from a battery seal. See, for example, Hull et al., “Why Alkaline Cells Leak,” J. Electrochem. Soc., 124(3):332-339, (1977) and Davis et al., “Aspects of Alkaline Cell Leakage,” J. Electrochem. Soc. 125(12):1918-123 (1978). Evidence of alkaline electrolyte leakage can be visibly detected when a white powder is deposited around a battery cell seal. Alkaline electrolyte leakage may be attributable to alkaline electrolyte creepage along negatively polarized electrodes. Alkaline electrolyte leakage may be exacerbated by physical factors such as scratches or other physical deformations/imperfections in a seal and/or a current collector of a battery cell. Although the powdered alkaline electrolyte is generally safe for human contact, contact should be minimized because respiratory, eye, and skin irritation may occur. Moreover, loss of electrolyte can lead to a decline in battery cell performance.

Polymer materials, particularly flexible materials such as nylons and various rubbers, are commonly used to manufacture battery cell seals. Seals made from such materials can degrade over time, however, causing material failure and increased electrolyte creepage within the cell. Thus, it is known that battery cells are susceptible to electrolyte leakage, for example, due to electrolyte creepage, especially along the body of an anode current collector (which is commonly provided in the form of a nail). Of course, other physical phenomena may also cause electrolyte leakage. Prior attempts to prevent leakage in seal assemblies have been made by providing a sealant around the current collector to provide an additional sealing surface before the seal itself. However, existing seal assemblies have not been sufficiently effective at preventing electrolyte creepage, mainly due to material failure in the seal itself, which failure may be introduced during manufacture/assembly of the battery cells and/or caused and/or exacerbated over time.

### SUMMARY OF THE DISCLOSURE

According to one example, a seal assembly for a battery cell comprises a cross-linked grommet having an opening. A current collector having a head and a stem extending from the head is disposed in the opening, the stem and the cross-linked grommet forming an interference fit at the opening. The cross-linked grommet comprises a cross-linked polymer.

In a further example, a seal assembly for a battery cell comprises an irradiated, cross-linked grommet having an opening. A current collector having a head and a stem extending from the head is disposed in the opening, the stem and the irradiated, cross-linked grommet forming an interference fit at the opening. The irradiated, cross-linked grommet comprises a radiation-induced, cross-linked polymer.

According to another example, a battery cell comprises a housing including a first cover at a first housing end and a second cover at a second housing end. An anode and a cathode are disposed within the housing. A seal assembly is disposed proximate the first cover, the seal assembly including a current collector having a head and a stem extending from the head and a cross-linked grommet having an opening. The stem extends through the opening forming an interference fit with the cross-linked grommet. The cross-linked grommet comprises a cross-linked polymer.

According to another example, a battery cell comprises a housing including a first cover at a first housing end and a second cover at a second housing end. An anode and a cathode are disposed within the housing. A seal assembly is disposed proximate the first cover, the seal assembly including a current collector having a head and a stem extending from the head and an irradiated, cross-linked grommet having an opening. The stem extends through the opening forming an interference fit with the irradiated, cross-linked grommet. The irradiated, cross-linked grommet comprises a radiation-induced, cross-linked polymer.

According to another example, a method of manufacturing a battery cell including a cross-linked grommet comprises providing a pre-formed grommet comprising a precursor polymeric material; cross-linking the precursor polymeric material to form a cross-linked grommet comprising a cross-linked polymer; and, incorporating the cross-linked grommet in a battery cell.

According to another example, a method of manufacturing a battery cell with an irradiated grommet comprises providing a pre-formed grommet comprising a precursor polymeric material; irradiating the precursor polymeric material to form an irradiated, cross-linked grommet comprising a radiation-induced, cross-linked polymer; and, incorporating the irradiated, cross-linked grommet in a battery cell.

According to another example, a cross-linked grommet for a battery cell comprises an annular polymer disc having an outer peripheral wall and a central boss surrounding a central opening for receiving a current collector. A polymeric material of the annular polymer disc is cross-linked.

According to another example, an irradiated, cross-linked grommet for a battery cell comprises an annular polymer disc having an outer peripheral wall and a central boss surrounding a central opening for receiving a current collector. The annular polymer disc comprises a radiation-induced, cross-linked polymer.

In yet another example, a battery cell comprises a housing including a first cover at a first housing end and a second cover at a second housing end, and an anode and a cathode disposed within the housing; and a cross-linked grommet proximate the first cover, the cross-linked grommet comprising a cross-linked polymer.

In a further example, a battery cell comprises a housing including a first cover at a first housing end and a second cover at a second housing end, and an anode and a cathode disposed within the housing; and an irradiated, cross-linked grommet proximate the first cover, the irradiated, cross-linked grommet comprising a radiation-induced, cross-linked polymer.

The foregoing examples of a cross-linked grommet for a battery cell, an irradiated grommet for a battery cell, a seal assembly, a battery cell, and/or a method of forming a battery cell may further include any one or more of the following optional features, structures, and/or forms.

In all forms, the cross-linked grommet comprises a cross-linked polymer. Similarly, in all forms, the irradiated, cross-linked grommet comprises a cross-linked polymer, specifically, a radiation-induced, cross-linked polymer.

In some optional forms, the cross-linked polymer is prepared by a process comprising adding a cross-linking agent to a polymer mixture prior to formation of the grommet. The cross-linking agent may be chosen from one or more cross-linking agents in the group of peroxide cross-linking agent, a silane cross-linking agent, a bis(maleimide) cross-linking agent, triallylcyanurate, triallylisocyanurate, trimethylolpropane triacrylate, and trimethylolpropane trimethacrylate. Combinations of the foregoing cross-linking agents as well as combinations of one or more of the foregoing cross-linking agents with other cross-linking agents may be used.

In yet other optional forms, the cross-linked polymer is prepared by a process comprising exposing a precursor polymer material to radiation chosen from e-beam radiation, gamma ray radiation, or a combination thereof. Generally, a pre-formed grommet comprising a precursor polymeric material is exposed to radiation, thereby forming a cross-linked grommet comprising a radiation-induced cross-linked polymer.

In yet other optional forms, the cross-linked polymer comprises a radiation-induced, cross-linked nylon, preferably, by radiation-induced cross-linking of a precursor nylon having a relatively low oxygen atom content, such as, for example, Nylon 6/12s, Nylon 11s, Nylon 12s, or a combination thereof. Combinations of the foregoing cross-linked nylons as well as combinations of one or more of the foregoing cross-linked nylons with other polymers, for example, other cross-linked polymers, may be used. Typically, a pre-formed grommet comprising a precursor nylon is exposed to radiation to induce cross-linking in the grommet prior to incorporation of the irradiated, cross-linked grommet into a battery or battery seal assembly but after formation of the grommet itself. Alternatively, a precursor nylon may be cross-linked by irradiation to form an irradiation-induced, cross-linked nylon prior to grommet formation.

In yet other optional forms, the precursor polymeric material or pre-formed grommet comprising the same is irradiated at a dose (amount) of least 50 kGy, at least 100 kGy, at least 125 kGy, at least 150 kGy, at least 200 kGy, and/or at least 250 kGy, for example, 300 kGy, 350 kGy, or greater.

In yet other optional forms, the cross-linked polymer comprises a cross-linked polymer chosen from one or more cross-linked polymers in the group of cross-linked low-density polyethylenes (LDPEs), cross-linked high-density polyethylenes (HDPEs), cross-linked atactic polypropylenes (PPs), cross-linked isotactic PPs, cross-linked polyvinyl chlorides, cross-linked polypropylene oxides, cross-linked polyvinyl acetates, cross-linked polybutadienes, cross-linked polystyrenes, cross-linked polymethyl acrylates, cross-linked polymethyl methacrylates. Combinations of the foregoing cross-linked polymers as well as combinations of one or more of the foregoing cross-linked polymers with other cross-linked polymers may be used.

In yet other optional forms, the grommet comprises a short boss or a long boss.

In yet other optional forms, the engagement interference between the grommet and the current collector is greater than 15%, greater than 17.5%, and/or greater than 19%, for example, about 20%.

In yet other optional forms, the gel content of the cross-linked polymer is greater than 50%, greater than 70%, and/or greater than 90%.

### BRIEF DESCRIPTION OF THE DRAWINGS

While the specification concludes with claims particularly pointing out and distinctly claiming the subject matter, which is regarded as forming the present invention, the invention will be better understood from the following description taken in conjunction with the accompanying drawing.

FIG. 1 is a cross-sectional view of a seal assembly for a battery cell, the seal assembly comprising a cross-linked grommet.

FIG. 2 is a cross-sectional view of a further embodiment of a seal assembly comprising a cross-linked grommet.

FIG. 3A is a graph illustrating a percentage of total number of AA battery cells comprising an irradiated, cross-linked grommet showing signs of leakage vs irradiation dose at 2 weeks relative to a comparative AA battery cell comprising a non-cross-linked grommet.

FIG. 3B is a graph illustrating a percentage of total number of AA battery cells comprising an irradiated, cross-linked grommet showing signs of leakage vs irradiation dose at 8 weeks relative to a comparative AA battery cell comprising a non-cross-linked grommet.

FIG. 3C is a graph illustrating a percentage of total number of AA battery cells comprising an irradiated, cross-linked grommet showing signs of leakage vs irradiation dose at 14 weeks relative to a comparative AA battery cell comprising a non-cross-linked grommet.

FIG. 4A is a graph of molecular weight changes in the precursor polymer material of a grommet comprising a specific exemplary polymer, nylon 6/12, post-exposure of the grommet to varying levels of irradiation.

FIG. 4B is a graph of molecular weight changes in the precursor polymer material of a grommet comprising a specific exemplary polymer, HDPE, post-exposure of the grommet to varying levels of irradiation.

FIG. 5 is a cross-sectional view of an example battery cell having a jelly-roll configuration.

### DETAILED DESCRIPTION

Electrochemical cells, or batteries, may be primary or secondary. Primary batteries are meant to be discharged, e.g., to exhaustion, only once and then discarded. Primary batteries (or disposable batteries) are described, for example, in David Linden, Handbook of Batteries (4^{th} ed. 2011), which is hereby incorporated by reference. Secondary batteries (or rechargeable batteries) are intended to be recharged and used over and over again. Secondary batteries may be discharged and recharged many times, e.g., more than fifty times, a hundred times, or more. Secondary batteries are described, for example, in David Linden, Handbook of Batteries (4^{th} ed. 2011), which again is hereby incorporated by reference. Accordingly, batteries may include various electrochemical couples and electrolyte combinations. The description and examples provided herein apply to both primary and secondary batteries of aqueous, nonaqueous, ionic liquid, and solid state systems. While consumer, single-use primary alkaline battery cells are the main focus of the accompanying description, the following description may be equally applied to any battery cell, including but not limited to rechargeable alkaline battery cells, such as rechargeable alkaline manganese (RAM) battery cells, lithium ion battery cells, as well as any other type of battery cell that includes an electrolyte solution, whether aqueous or non-aqueous.

Surprisingly and unexpectedly, seal assemblies comprising a cross-linked grommet as described herein demonstrate improved performance, as demonstrated by a reduction in leakage in battery cells containing the same. As previously described, conventional grommets typically have comprised a flexible material and thus it is counter-intuitive to use a more rigid material (which results from cross-linking) for the same as such materials would be expected to be more susceptible to crack and craze formation. It should be understood that the term “grommet” is used interchangeably with the term “seal” herein.

Advantageously, the cross-linked grommets according to the disclosure may be included in any type of electrochemical battery cell including an electrolyte. For example, the cross-linked grommets according to the disclosure may be employed in consumer electrochemical cells of any size and/or shape (including but not limited to batteries having cylindrical shapes, rectangular shapes, square shapes, or cross-sectional forms of the foregoing) including, but not limited to, AAAA cells, AAA cells, AA cells, B cells, C cells, D cells, 9V cells, and the like. The disclosed cross-linked grommets are particularly advantageous when incorporated into alkaline electrochemical cells, particularly alkaline cells including a seal assembly comprising the disclosed, cross-linked grommet and a current collector disposed in a bore of the cross-linked grommet.

As used herein, the terms “cross-linked” and “cross-linking treatment” refer to cross-linked polymer structures resulting from purposeful cross-linking, methods for cross-linking a precursor polymer, and/or methods for cross-linking a pre-formed grommet by exposure of the pre-formed grommet to a cross-linking treatment post-grommet formation. As is well known, grommet formation is typically carried out using injection molding techniques. Cross-linking of a typically, non-cross-linked precursor polymer may be accomplished using known techniques that promote cross-linking of the precursor polymer, for example, by adding a cross-linking agent to the precursor polymer and initiating cross-linking, and/or by exposing the precursor polymer to irradiation. In one example, cross-linking may be accomplished during grommet formation by adding a cross-linking agent to the precursor polymer to form a mixture and injection molding the mixture as the requisite temperature increase will cause the precursor polymer and cross-linking agent to react. Other techniques for cross-linking the precursor polymer prior to, during, or subsequent to molding may also be used alone or in combination. Examples of post-grommet formation cross-linking treatments include exposure of a pre-formed grommet comprising a precursor polymer material to irradiation or exposure of a pre-formed grommet comprising a precursor polymer material to a chemical bath. Other techniques that promote cross-linking of a pre-formed polymer component such as a grommet may also be used. In all of these instances, the precursor polymer of the pre-formed grommet may further comprise a cross-linking agent to facilitate purposeful cross-linking. The cross-linking treatments promote cross-linkage formations in both the exposed polymeric grommet surfaces as well as in the polymer bulk material beyond the exposed polymeric surfaces (e.g., within the internal structure of the polymeric grommet).

As used herein, the term “irradiation” refers to exposure to e-beam, gamma radiation, or a combination of the foregoing in a dosage amount sufficient to induce cross-linking.

As used herein, the term “cross-linked grommet” refers to a grommet comprising a polymeric material that includes cross-links between polymeric chains, the cross-links may be formed by any cross-linking process, including, for example, irradiation, initiation/promotion of chemical reactions that cause cross-links to form, or combinations thereof. The cross-linking process may be completed pre-, in-, or post-formation of the grommet. In instances where cross-linking is carried out before or during formation of the grommet, a typically non-cross-linked precursor polymer material is cross-linked prior to and/or during grommet formation such that cross-linked polymer material is used to form the grommet. With particular reference to cross-linking conducted post-grommet formation, it is understood that the term “cross-linked grommet” refers to a grommet having a different polymer structure than a grommet comprising the precursor polymer material (that has not been subjected to a purposeful cross-linking treatment).

As used herein, the term “irradiated, cross-linked grommet” refers to a grommet comprising a polymeric material that includes cross-links between polymeric chains, the cross-links being created by exposing the grommet to irradiation after the grommet is formed into its final shape. Typically, irradiating the pre-formed grommet is conducted before the grommet is installed in a battery cell. Exposure of the “pre-formed grommet” comprising a precursor polymer material to a sufficient dosage of irradiation causes cross-links to form in the precursor polymer material, thereby forming an irradiated, cross-linked polymer grommet including cross-links within the internal structure of the polymeric grommet. It is therefore understood that the term “irradiated, cross-linked grommet” refers to a grommet having a different polymer structure than a grommet comprising a precursor polymer material (that has not been subjected to a purposeful cross-linking treatment).

As used herein, the term “engagement interference” refers to engagement interference between the current collector and the grommet, specifically, the ratio of the outer diameter of the current collector less the internal diameter of a bore of the grommet, i.e., the grommet opening, to the internal diameter of the grommet opening. While the current collector outer diameter is conventionally larger than the internal diameter of the grommet to provide an interference fit and thereby enhance sealing properties, the engagement interference is typically less than 15% in prior art battery cells to facilitate battery cell assembly.

As used herein, the term “gel” refers to a state of matter that is interconnected in an agglomerate that can no longer be dissolved in various solvents. Higher amounts of gel indicate a greater the number of cross-link bonds between polymer chains. Such bonding advantageously prevents the material from dissolving in solvents and increases resistance to temperature variations, and also increases the rigidity of the polymer material.

As used herein, the term “about” means+/−10% of any recited value, or in an alternative embodiment, +/−5% of any recited value. As used herein, this term modifies any recited value, range of values, or endpoints of one or more ranges.

Irradiated grommets are created by exposing a fully formed grommet to electron beam radiation, gamma rays, or a combination of the foregoing. To create irradiated grommets, a set of fully pre-formed grommets may be subjected to one or more irradiation treatments, for example, using an electron beam accelerator including a conveyor.

Thus, an irradiation treatment can include passing a set of pre-formed grommets through a zone of radiation to administer an amount of radiation, typically from about 25 kGy to about 50 kGy. If multiple irradiation treatments are performed on a set of pre-formed grommets to provide a cumulative dose of radiation, it may be advantageous to change relative positions of the grommets between treatments to ensure more uniform radiation exposure among the grommets. Typically, the energy of the-beam is between about 1 MeV and about 4.5 MeV and the power of the accelerator is between 25 kW and 200 kW. For example, a 1.5 MeV, 75 kW accelerator may be used. Wasik, IOTRON, and IBA all manufacture suitable e-beam accelerators.

In embodiments, a pre-formed grommet comprising a precursor polymer material may further contain cross-linking agents distributed or dispersed throughout a matrix of the precursor polymer material. The cross-linking agents may be embedded or otherwise dispersed throughout the pre-formed grommet matrix of precursor polymer material. Molding of the precursor polymer material to form the grommet involves increasing the temperature such that reaction of the precursor polymer with the cross-linking agent and thus cross-linking of the precursor polymer can occur during grommet formation. In addition, irradiation of pre-formed grommets in which cross-linking agents are embedded advantageously generates additional cross-links between polymer chains in the grommet (relative to the amount of cross-links created solely by injection molding the mixture of the precursor polymer and cross-linking agent and also relative to the amount of cross-links created solely by irradiation), due to (additional) reaction of polymer chains with the embedded cross-linking agents upon irradiation. The additional cross-links created by reaction of facilitators or cross-linking agents may further improve mechanical properties of the irradiated, cross-linked grommets.

In other embodiments, grommets may be cross-linked prior to further irradiation treatment. For instance, cross-linked grommets may be formed by fabricating grommets comprising a precursor polymer material by injection molding of a precursor polymer material with cross-linking agents embedded therein as described above, optionally followed by further treatment (for instance, heat treatment or immersion in a chemical bath) to initiate or cause additional reaction of remaining embedded cross-linking agents within the precursor polymer material, and thereby provide additional cross-links between polymer chains within the grommet. Subsequent irradiation of such cross-linked grommets would generate further cross-links between polymer chains within the grommet.

Numerous cross-linking agents may be used. Cross-linking agents containing multiple reactive functional groups, such as vinyl groups, can react with multiple polymer chains to create cross-links. Free radical initiator cross-linking agents, silane coupling agent cross-linking agents, and chain extender cross-linking agents may also be used. Suitable cross-linking agents for distribution or dispersion throughout a matrix of the precursor polymer material as described above include but are not limited to peroxides, such as, for example, hydrogen peroxide, benzoyl peroxide, dilauryl peroxide, and dicumyl peroxide; silanes, such as, for example, vinyltrimethoxylsilane, vinyltriethoxysilane, 3-(trimethoxysilylpropyl methacrylate, vinyltris(2-methoxyethoxy)silane, vinyltris(methylethylketoxime)silane, (3-aminopropyl)triethoxysilane, (3-aminopropyl)trimethoxysilane, (N-2-aminoethyl-3-aminopropyl)trimethoxysilane; bis(maleimide) compounds, such as, for example, N,N′-(1,2-phenylene)dimaleimide, N,N′-(1,3-phenylene)dimaleimide, N,N′-(1,4-phenylene)dimaleimide 1,4-di(maleimido)butane, N,N′-(methylenebis(1,4-phenylene))-bis(maleimide); triallylcyanurate, triallylisocyanurate, trimethylolpropane triacrylate, and trimethylolpropane trimethacrylate. In addition, cross-linking agents available under the NEXAMITE® (Nexam Chemical) tradename may be used including but not limited to NEXAMITE® A32 and NEXAMITE® A33 (for cross-linking nylon containing precursor polymer materials), and NEXAMITE® A48 and NEXAMITE® A49 (for cross-linking polyethylene containing precursor polymer materials). Of course, the foregoing cross-linking agents are merely exemplary and other cross-linking agents may be used.

When a cross-linking agent is employed, typically, the cross-linking agent is added to the precursor polymer material such that it is distributed or dispersed throughout a matrix of the precursor polymer material prior to forming the grommet. Cross-linking may be initiated before grommet formation, during grommet formation, and/or post-grommet formation as discussed above. Cross-linking agents may be particularly effective at promoting more uniform formation of cross-links throughout the matrix of the precursor polymer material.

In one embodiment, a method of manufacturing an alkaline battery cell with a cross-linked grommet comprises providing a pre-formed grommet comprising a precursor polymeric material. The pre-formed grommet is exposed to a cross-linking treatment, such as radiation and/or a chemical cross-linking bath, to cross-link the precursor polymeric material, thereby forming a cross-linked grommet. The cross-linked grommet can be incorporated into a battery cell, for example, a primary battery cell, or a secondary battery cell. A seal assembly comprising the cross-linked grommet and a current collector disposed in a bore of the cross-linked grommet can also be formed. Thereafter, the cross-linked grommet and/or the seal assembly comprising the same can be disposed in a battery cell including an electrolyte, for example, a primary battery cell, or a secondary battery cell.

In one example, the method comprises exposing a pre-formed grommet to radiation, such as electron beam (e-beam), gamma rays, or a combination thereof, to form an irradiated, cross-linked grommet. When e-beam radiation is used, doses of at least 40 kGy, of at least 50 kGy, at least 100 kGy, at least 125 kGy, at least 150 kGy, at least 200 kGy, and/or at least 250 kGy, for example, 300 kGy, 350 kGy, 400 kGy, or even greater, may be particularly useful in providing and/or maximizing the chemical cross-links in the polymer material. For example, the e-beam radiation dose may be between about 40 kGy and less than 500 kGy, between about 50 kGy and about 450 kGy, and/or between 75 kGy and about 400 kGy. Doses in amounts of between about 250 kGy and about 400 kGy have been shown to be advantageous for cross-linking pre-formed grommets, particularly cross-linked grommets comprising thermoplastic polyolefins including but not limited to polyethylenes such as ultra-high-density polyethylenes (UHDPEs), low-density polyethylene (LDPEs), and high-density polyethylene (HDPEs), polypropylenes such as atactic polypropylenes (PP) and isotactic PPs, and polyvinyl chlorides and having an engagement interference greater than 15%. E-beam radiation may be accomplished, for example, using an electron gun to generate and accelerate a primary beam, and, a magnetic optical system to focus and deflect the beam. Multiple passes in smaller dose increments, for example, in increments such as 10 kGy, 20 kGy, 25 kGy, 30 kGy, or 50 kGy, are generally used to achieve the desired dosage. Higher increments can be also used as long as the structure of the grommet is not overheated such that it deforms. Energy of the electron beam can vary between 300 keV and 20 MeV, between 1 MeV and 10 MeV, between 3 MeV and 10 MeV, for example, a 4.5 MeV electron beam may be used.

The strength properties of a cross-linked grommet may be further improved by annealing the cross-linked grommet, for example, by applying heat, after completion of the cross-linking treatment and/or irradiation process. Annealing takes place at a temperature greater than 25° C., preferably between 40° C. and 135° C., but less than the melting point of the cross-linked polymer. Generally, annealing is accomplished by treatment in a bath for a period of one or more hours, typically, at least about 4 hours, and then the cross-linked grommet is cooled to room temperature. Without intending to be bound by theory, it is believed that the annealing process increases mobility of chains relative to one another, which facilitates completion of cross-linking chemical reactions with free radicals within the grommet polymer matrix that did not complete a cross-linking reaction, for example, after exposure to radiation, chemical immersion bath, and/or during grommet formation. Additional bonds between polymer chains are therefore formed and tensile properties of the polymer material may further be improved as a result of annealing.

In any embodiment, the current collector, which may be a nail, may comprise a conductive metal, for example, a brass alloy or a bronze alloy (including silicon bronze). Brass alloys having a copper content greater than about 50% by weight, for example, 60 wt. % or 70 wt. % and a zinc content greater than 20 wt. %, for example, 30 wt. % or 40 wt. % may be used.

Generally, thermoplastic polymers may be used to form the cross-linked grommet according to the disclosure. For example, nylons such as Nylon 6s, Nylon 6/6s, Nylon 4/6s, Nylon 3s, Nylon 12s, Nylon 11s, and Nylon 6/12s, Nylon 10/20s, Nylon 10/12s, Nylon 6/10s, Nylon 4/12s, and Nylon 4/10s, and other thermoplastic polymers including but not limited to polyethylenes such as ultra-high-density polyethylenes (UHDPEs), low-density polyethylenes (LDPEs), and high-density polyethylenes (HDPEs), polypropylenes such as atactic polypropylene (PPs) and isotactic PPs, polyvinyl chlorides, polypropylene oxides, polyvinyl acetates, polybutadienes, polystyrenes, polymethyl acrylates, polymethyl methacrylates, or a combination thereof may be used. The cross-linked polymeric materials of the seals disclosed herein are preferably nonionic, cross-linked polymers.

Because nylons are polyamides, all nylons exhibit hydrogen bonding (C═O . . . H—N) between neighboring polymer chains. In general, increased hydrogen bonding between polymer chains imparts improved mechanical properties to a polymeric material without causing the material to be too rigid. For nylons in particular, one would expect the amount of hydrogen bonding to scale with the density of amide groups in the polymer; that is, given two nylon polymers, the one with more amide groups would be expected to exhibit more hydrogen bonding. For nylons, the density of amide groups depends on the chain lengths of the precursor molecules. Increasing the chain lengths of the precursors increases the number of C—C bonds between amide groups on the polymer chain, resulting in a lower density of amide groups in the polymer. As such, nylons made from short-chain precursors have a higher density of amide groups, and are thus expected to exhibit a greater degree of hydrogen bonding and be more suitable for grommets for battery cells, than nylons made from longer-chain precursors. Accordingly, a group of suitable polymers for the fabrication of grommets with favorable mechanical strength includes Nylon 6s, Nylon 6/6s, and Nylon 4/6s, all of which would be expected to exhibit a greater degree of hydrogen bonding, and thus superior mechanical properties, compared to nylons prepared from longer-chain precursors, such as Nylon 12s, Nylon 11s, and Nylon 6/12s. Surprisingly, this is not the case.

One way to compare the structure of various nylons is to note the number of oxygen atoms as a percentage of non-hydrogen atoms (“% O”) in each polymer. For instance, for Nylon 6, the repeat unit is C₅H₁₀C(═O)NH, and the % O is accordingly 1/8=12.5%, while for Nylon 12, the repeat unit is C₁₁H₂₂C(═O)NH, and the corresponding % O is 1/14=7.1%. In general, polymers with greater % O have a greater density of amide groups and accordingly would be expected to exhibit a greater degree of hydrogen bonding, and thus superior mechanical properties, compared to polymers with lower % O. Thus, as mentioned above, shorter-chain nylons having greater relative amounts of hydrogen bonding are expected to have superior mechanical properties. Surprisingly, however, cross-linked grommets comprising longer-chain, lower % O nylons such as Nylon 12s, Nylon 11s, or Nylon 6/12s perform comparably or even better than grommets made of shorter-chain nylons such as Nylon 6/6. For example, surprisingly and unexpectedly the mechanical properties of irradiated, cross-linked Nylon 6/12s (% O=9.1%) are nearly equal to those of non-irradiated, non-cross-linked Nylon 6/6s (% O=12.5%), which is generally considered in the industry to provide the most effective grommets but is extremely costly. Furthermore, surprisingly and unexpectedly, irradiated, cross-linked grommets comprising Nylon 6/12 exhibit superior leak prevention even when compared to comparably irradiated, cross-linked grommets comprising Nylon 6/6. Thus, cross-linked Nylon 6/12, which has superior leak performance to cross-linked Nylon 6/6, is a particularly useful material for cross-linked grommets for battery cells.

On the other hand, polymers like Nylon 4-6s, Nylon 6s, Nylon 6-6s and Nylon 3s having % O values exceeding 12% have excellent hydrogen bonding and satisfactory tensile properties in dry conditions, but surprisingly these polymers are susceptible to increased degradation in the presence of water such that their tensile properties decrease in battery cells comprising aqueous electrolytes. In particular, Nylon 6-6 is relatively stable in electrolytes comprising high alkali hydroxide concentrations greater than 30 weight percent (wt. %), on a weight basis of the total electrolyte within the battery cell, but more susceptible to decomposition such that cracks can more readily form in the grommets at relatively lower alkali hydroxide concentrations of less than 30 wt. %, less than 25 wt. %, and less than 20 wt. %. The alkali hydroxide may be, for example, potassium hydroxide, cesium hydroxide, or any combination thereof, but typically is potassium hydroxide. Without intending to be bound by theory, the higher the number of oxygen atoms in nylon or other polymer material, the higher the moisture content at saturation and the greater the rate of hydrolysis and thus material failure over time. As a result, nylons with lower % of oxygen atoms in the structure, e.g. Nylon 6-12s, Nylon 12s, Nylon 11s, or even polyolefins like HDPEs or LDPEs with 0% of oxygen atoms within the structure are surprisingly preferred, even though the tensile properties of such plastics are reduced due to the presence of relatively less hydrogen bonding (e.g., between amide groups of adjacent polymer chains —O═O·H—N—) between the polymeric chains. For example, without intending to be bound by theory, the inventors found that grommets made of nylon react with any water present in the electrolyte (through hydrolysis), which causes the nylon to degrade and break down, eventually causing cracks in the material that allow electrolyte creepage. Cross-linking of grommets comprising longer-chain, lower % O nylons such as Nylon 12s, Nylon 11s, or Nylon 6/12s, especially, advantageously enhances the resistance of the cross-linked grommet to hydrolysis.

Moreover, again, without intending to be bound by theory, the inventors found that grommets made of polyolefins such as polyethylenes and polypropylenes, while not prone to hydrolysis, also tend to develop cracks, especially under pressure. Such cracks are problematic for any battery cell seal or grommet, including but not limited to when the current collector is provided in the form of a nail. For example, the cracks and crazes that form in the grommet due to this structural degradation ultimately causes seal failure and/or creepage of the electrolyte solution between the nail and the grommet. Cross-linking of grommets comprising polyolefins such as polyethylene and polypropylene, especially, advantageously enhances the material strength of the cross-linked grommets such that fewer cracks are formed in the cross-linked grommets, which is particularly surprising given the increase in rigidity of the material that results from cross-linking of the precursor polymer material would be expected to cause the cross-linked material to be more susceptible to crack and craze formation.

Thus, polymers such as polyethylenes such as UHDPEs, HDPEs, and LDPEs, polypropylenes such as atactic PPs and isotactic PPs, polyvinyl chlorides, polybutadienes, polystyrenes, Nylon 10/20s, Nylon 12s, Nylon 11s, Nylon 10/12s, Nylon 6/12s, Nylon 6/10s, Nylon 4/12s, and Nylon 4/10s, which all contain less than 12% O, are expected to provide improved properties upon cross-linking and/or enhanced resistance to degradation by hydrolysis, which is surprising and unexpected, particularly in view of our findings that nylons in general are susceptible to hydrolysis and other thermoplastic polymers such as polyolefins are susceptible to material failure. Polymers with less than 12% O, less than 10% O, less than 8% O, and/or less than 5% O, are particularly useful for cross-linked grommets for battery cells.

Increasing the engagement interference between the grommet and the current collector relative to the current state of the art has been found to surprisingly and advantageously enhance grommet performance despite increased strain on a more rigid material as demonstrated by reduced leakage. The engagement interference may be greater than 15%, greater than 17.5%, and/or greater than 19%, for example, about 20%, or even higher. Such increased engagement interference is particularly advantageous for grommets comprising cross-linked polyethylenes such as UHDPEs, HDPEs, and LDPEs, cross-linked polypropylenes such as atactic PPs and isotactic PPs, and cross-linked nylons such as Nylon 6-12d, Nylon 12s, and Nylon 11s.

Furthermore, by increasing levels of cross-linking, for example, by using higher amounts of irradiation, additional cross-links between adjacent polymer chains are formed. These additional cross-links can be measured and detected as an increase in molecular weight relative to the molecular weight of the polymer precursor material. During testing, increases in molecular weight of more than 10-fold were demonstrated using size exclusion chromatography, after exposure of a grommet comprising a precursor polymer including Nylon 6-12 to 200 kGy of irradiation, thereby confirming formation of cross-links between polymer chains. Generally, cross-linked polymers with higher molecular weight surprisingly demonstrate better tensile properties and less creepage, and can better withstand the temperature variations to which electrochemical battery cells are frequently exposed during storage and transport, while surprisingly providing a better performing grommet/seal in the electrochemical battery cell.

In another example, as the radiation dose was increased above 200 kGy, a gel was formed inside a grommet comprising a precursor polymer material including Nylon 6-12. Advantageous grommet performance is demonstrated when the gel content of the cross-linked polymer is greater than 50%, greater than 70%, and/or greater than 90%.

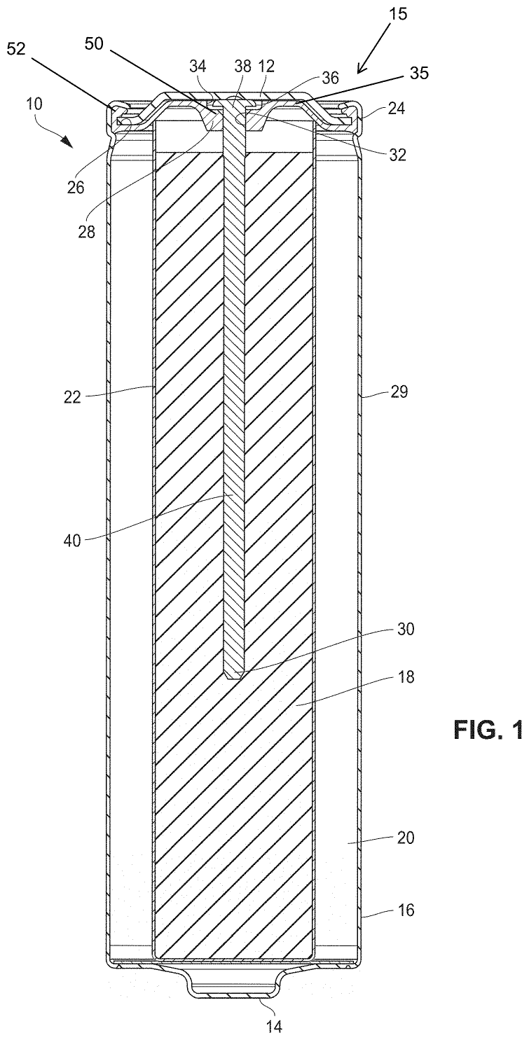

Turning now to FIG. 1, one example of an alkaline battery cell 10 including an exemplary seal assembly 15 according to the disclosure, is illustrated. The seal assembly 15 comprises a current collector or nail 30 and a cross-linked grommet or seal 28.

The battery cell 10 includes first and second covers 12, 14, which correspond to the negative and positive battery terminals, respectively, with a housing 16 generally being disposed therebetween. To separate an anode 18 from a cathode 20, the battery cell 10 includes a separator 22. To close an end 24 after the components of the battery cell 10 are disposed within the housing 16, the first cover 12 is received within a groove 26 formed in an outer peripheral wall 52 of the cross-linked grommet 28, and a sidewall 29 of the housing 16 is crimped over a peripheral edge of the cross-linked grommet 28, such that the cross-linked grommet 28 is enclosed within the housing 16. In some examples, the cross-linked grommet 28 is spaced from the cathode 20 to enable the cathode 20 to expand. In some examples, the cross-linked grommet 28 is spaced from the anode 18 to enable the anode 18 to expand. The cross-linked grommet 28 is annular in shape in the illustrated example to cover the end of the substantially cylindrical sidewall 29.

To couple the anode current collector 30 and the first cover 12, which provides a negative terminal in the assembled battery cell 10, in this example, the cross-linked grommet 28 includes a first opening or bore 32 having a wider portion 34 defining a head clearance or space 36, where an end or head 38 of the anode current collector 30 is positioned and electrically coupled to the first cover 12. This space 36 may have a chamfered or angled configuration to accommodate the head 38. In this example, a body 40 of the anode current collector 30 extends through the first opening 32 and into the anode 18. The first opening 32 may be surrounded by a boss 50, which in the illustrated example is a short boss. The first opening 32 has an internal diameter generally corresponding to the outer diameter of the current collector/nail 30. The outer diameter of the current collector 30 is typically larger to provide an interference fit between these components of the seal assembly 15, and in some preferred embodiments, the outer diameter of the current collector 30 is at least 15% larger than the internal diameter of the first opening 32 as set forth above.

As used herein, a short boss refers to a boss 50 that extends either below a generally flat annular portion or shelf 35 of the cross-linked grommet 28, or above the shelf 35, but not both. In other examples, which are described further below, the boss 50 may be a long boss. As used herein, a long boss refers to a boss 50 that extends both above and below the shelf 35 of the cross-linked grommet 28.

An electrolyte solution is contained within the housing 16, the electrolyte solution facilitating chemical reactions between the anode 18 and the cathode 20. The electrolyte may be an alkali hydroxide, for example, potassium hydroxide, cesium hydroxide, or any combination thereof, but typically is potassium hydroxide.

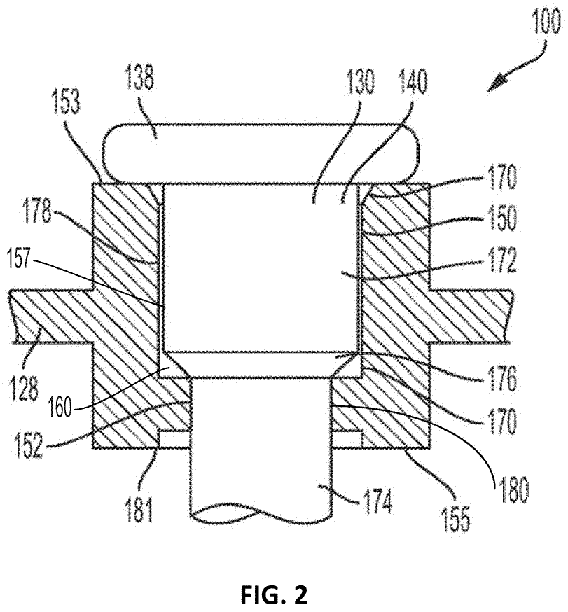

To further reduce electrolyte creepage, in an additional embodiment, the cross-linked grommet described above may be implemented in a long boss design and further combined with a sealant trap, as illustrated in FIG. 2, and as disclosed for example in U.S. Patent Publication No. 2021/0367297A1, the entirety of which is hereby incorporated by reference herein. As illustrated in FIG. 2, a seal assembly 100 may comprise a cross-linked grommet 128 having an opening or bore 150. When assembled, the top 153 of the cross-linked grommet 128 is adjacent a cover that provides a negative terminal for the battery cell and a bottom 155 of the cross-linked grommet 128 is disposed closer to the anode, cathode, and the electrolyte of the battery cell. A current collector or nail 130 comprises a nail head 138 and a body or stem extending from the nail head 138.

When assembled, the stem 140 extends through the opening 150 of the cross-linked grommet 128 from the top 153 through the bottom 155 and the nail head 138 seats in a headspace near the top 153. As assembled, the stem 140 and the cross-linked grommet 128 form a first interference fit 152 and a second interference fit 157. Each of the first and second interference fits 152, 157 may have an engagement interference greater than 15%, greater than 17.5%, and/or greater than 19%, for example, about 20%. When assembled, a trap clearance 160 is formed radially and longitudinally between the stem 140 and the bore 150, between the first interference fit 152 and the second interference fit 157. The trap clearance 160 defines a trap 160 for a sealant 170. The sealant 170 is disposed around the stem 140 and is located at least partially in the trap 160 and forms an additional sealing surface which cooperates with the first and second interference fits 152, 157 to form an enhanced seal that reduces or prevents electrolyte from escaping the battery cell.

The stem 140 of the nail 130 includes a first portion 172 with a first stem diameter and a second portion 174 with a second stem diameter. The second stem diameter is smaller than the first stem diameter. As illustrated, the first portion 172 and the second portion 174 of the stem 140 are joined by a chamfer 176, but a more “abrupt” stepped transition between the first portion 172 and the second portion 174 may also be used, provided that the second portion 174 has a smaller diameter than the first portion 172 as previously described. The first portion 172 of the stem 140 has an outer diameter that is greater than the internal diameter of the bore 150 as previously described.

The trap 160 is formed between the bore 150 and the second portion 174 of the stem 140. The trap 160 is bounded radially on an inner side by the outer surface of the second portion 174 and is bounded radially on an outer side by the inner surface of the bore 150. The trap 160 in the illustrated example forms an annular-shaped space.

An internal annular ring 180, protrudes from the inner surface of the bore 150. The internal annular ring 180 forms the first interference fit 152 with the second portion 174 of the stem 140 when the stem 140 is fully inserted into the cross-linked grommet 128, because the second stem outer diameter of the second stem 174 is greater than the annular ring 180 internal diameter as previously described. Optionally, a lower bore 181 having a wider diameter than the internal annular ring 180 may be included that opens into the internal components of the battery cell.

The trap 160 is located longitudinally along the stem 140 above the internal annular ring 180. In the example illustrated in FIG. 2, the trap 160 is bounded longitudinally by the internal annular ring 180 and the chamfer 176 when the stem 140 is fully inserted into the cross-linked grommet 128. Thus, the structural arrangement of the stem 140 in the bore 150 is purposefully arranged to provide a void—which is the trap 160 for the sealant 170.

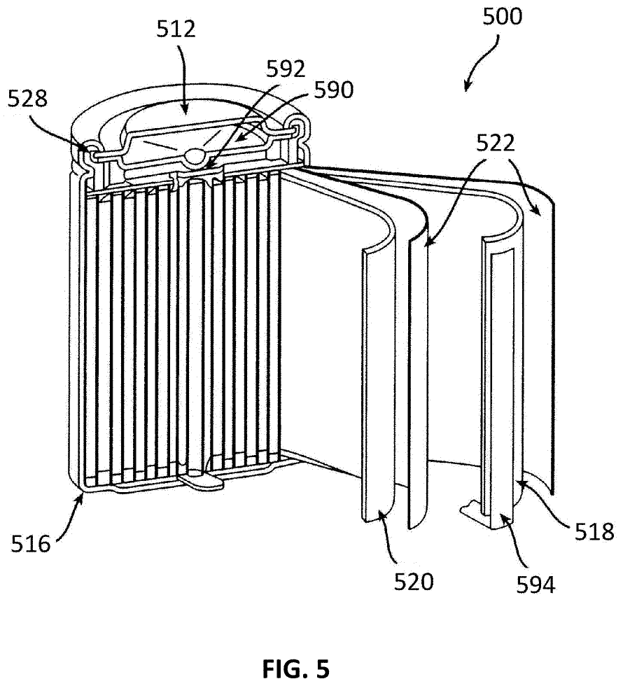

With specific reference to FIG. 5, in other embodiments, the anode 518 and the cathode 520 of electrochemical battery cell 500, which may be a primary or secondary cell, comprises a so-called “jelly-roll” configuration. One example of a jelly-roll configuration is described and illustrated in U.S. Pat. No. 11,081,721, the entirety of which is hereby incorporated by reference herein. Electrochemical battery cell 500 includes an anode 518 in electrical contact with a negative lead 594, a cathode 520 in electrical contact with a positive lead 592, a separator 522, and an electrolyte (not shown). Anode 518 and cathode 520, with separator 522 disposed therebetween, may be rolled to form the jelly-roll assembly. Anode 518, cathode 520, separator 522, and the electrolyte are contained within a housing 516. The cell 500 further includes a first cover 594 and an annular, insulating, cross-linked grommet 528 disposed proximate the first cover 594. The cell 500 may include a safety vent 530.

### EXAMPLES

The following examples further illustrate the advantages of battery cells including a cross-linked grommet as disclosed herein.

### Example A

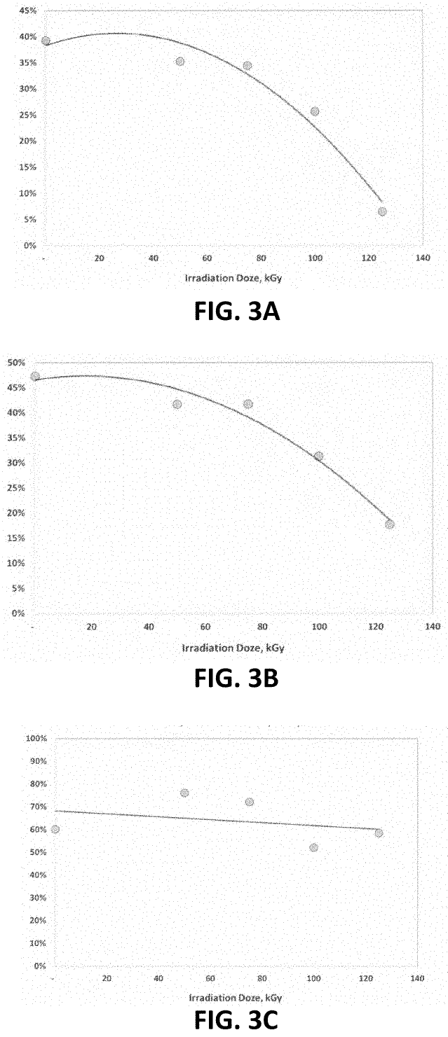

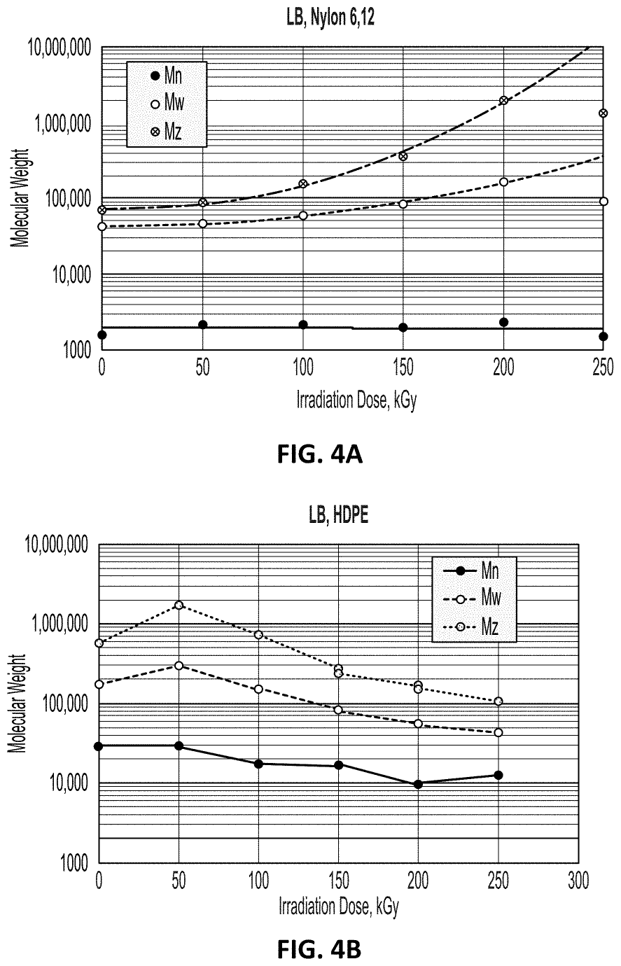

FIGS. 3A-3C are graphs illustrating test data for AA battery cells including irradiated, cross-linked grommets comprising cross-linked Nylon 6/6 (and exposed to different doses of e-beam radiation) relative to otherwise identical comparative AA battery cells including non-cross-linked Nylon 6/6 grommets (that were not exposed to any e-beam radiation). The battery cells were examined after 2, 8, and 14 weeks, respectively. The x-axis in the graphs represents irradiation dose (in kGy) and the y-axis in the graphs represents total number of cells exhibiting signs of leakage as a percentage of total cells in the test. Generally, as illustrated in FIGS. 3A-3C, the percentage of cells exhibiting signs of leakage significantly and surprisingly decreased as irradiation dose increased. While not being bound by theory, the improved leakage rates are thought to result from increased cross-linking in the polymer grommet due to higher doses of irradiation. The grommets of the test cells had a short boss design.

### Example B

Battery cells including cross-linked grommets (and exposed to different doses of e-beam radiation) were subjected to leak testing and compared to otherwise identical comparative control battery cells including non-cross-linked grommets. The battery cells had a KOH electrolyte solution including about 25 wt. % KOH. Cells were randomly taken from a control group (grommets not irradiated) and from an irradiated group (including cross-linked, irradiated grommets). The irradiated group included cross-linked grommets comprising Nylon 6/12 that were subjected to 200 kGy. The cells were then observed for evidence of leakage using a digital microscope at weekly intervals while the cells were held at elevated temperature conditions exceeding 50° C. intended to exacerbate any defects that may lead to leakage under normal battery storage conditions over 12 years of storage. Control cells having seals comprising non-irradiated Nylon 6/12 showed seven leaking cells out of thirty, after eight weeks, while the irradiated cells having seals comprising irradiated Nylon 6/12 showed zero cells leaking out of thirty after eight weeks. The grommets of the test cells had a short boss design.

### Example C

In a second example, battery cells including short boss grommets were tested under a temperature shock test in which the temperature is cycled between a relatively high temperature approaching 60° C. and a relatively low temperature of less than −25° C. and an elevated temperature and humidity test (approaching 60° C. and 85% relative humidity), so as to exacerbate any defects that may lead to leakage under normal battery storage conditions over 12 years of storage. The material used was Nylon 6/6. The seals of the control cells were not subject to irradiation and the seals of the irradiated cells were subject to radiation doses up to 125 kGy. After eight weeks, the cells subject to radiation showed a 65% reduction in leakage (92% of the control cells leaked whereas only 32% of the irradiated cells leaked) in the temperature shock test and a 33% reduction in leakage (12% of the controls cells leaked whereas only 8% of the irradiated cells leaked) in the temperature and humidity test.

### Example D

Additional battery cells were assembled to further demonstrate the advantageous performance of the cross-linked grommets disclosed herein. Specifically, battery cells including cross-linked grommets comprising Nylon 6/12 (“N 6/12”) or HDPE and including current collectors having different outer diameters to produce varying engagement interferences and exposed to different doses of e-beam radiation (groups B, C, D, E, F, G, H, I, and J) were subjected to leak testing and compared to otherwise identical comparative control battery cells including non-cross-linked grommets (group A). The battery cells had a KOH electrolyte solution including about 25 wt. % KOH. The control group A grommets were not irradiated and the groups B-J according to the disclosure were irradiated at the dose amounts shown in Table 1 below. The cells were subjected to an elevated temperature and humidity test (approaching 60° C. and 85% relative humidity), so as to exacerbate any defects that may lead to leakage under normal battery storage conditions over 12 years of storage, and observed for evidence of leakage at weekly intervals using a digital microscope with a 2500× lens (MXG-2500REZ lens, Hirox Co. Ltd., Japan). Control cells having a long boss trapped sealant design (as described herein) comprising non-irradiated Nylon 6/12 showed 6 leaking cells out of thirty, after eight weeks, whereas cells comprising irradiated grommets having a long boss design comprising irradiated Nylon 6/12 and irradiated HDPE showed surprisingly less leakage, particularly at higher levels of radiation. Specifically, the cells of groups B, C, and D had a long boss design without trapped sealant, the cells of E, F, and G had a long boss trapped sealant design, and the cells of groups H, I, and J had a long boss design without trapped sealant. Surprisingly, leakage performance of cells comprising irradiated HDPE (groups C, D, H, I, and J) was improved relative to the control group A including long boss grommets comprising non-irradiated Nylon 6/12, particularly at radiation amounts greater than 250 kGy, which is particularly surprising and advantageous because these cells do not include the trapped sealant that is capable of providing an additional sealing surface. Surprisingly improved leakage results were observed for cells comprising irradiated, cross-linked Nylon 6/12 and irradiated, cross-linked HDPE at radiation amounts greater than 200 kGy when engagement interference was increased relative to the control group A as shown in Table 1.

TABLE 1

| Group | | | | | | | | | | | | | |
|---|---|---|---|---|---|---|---|---|---|---|---|---|---|
| (number | | | | | | | | | | | | | Total |
| of cells | Seal | Radiation | Current | Engagement | Week | Week | Week | Week | Week | Week | Week | Week | Leak- |
| tested) | material | dose | Collector | interference | #1 | #2 | #3 | #4 | #5 | #6 | #7 | #8 | age |
| A (30) | N 6/12 | 0 | #1 | 12.28% | 0 | 0 | 0 | 0 | 0 | 0 | 0 | 6 | 20% |
| control | | | | | | | | | | | | | |
| B (30) | N 6/12 | 200 | #1 | 12.28% | 0 | 0 | 0 | 0 | 0 | 0 | 0 | 0 | 0% |
| | | kGy | | | | | | | | | | | |
| C (30) | HDPE | 200 | #1 | 12.28% | 0 | 0 | 0 | 0 | 1 | 0 | 0 | 2 | 10% |
| | | kGy | | | | | | | | | | | |
| D (15) | HDPE | 250 | #1 | 12.28% | 0 | 0 | 0 | 0 | 0 | 0 | 2 | 0 | 13.3% |
| | | kGy | | | | | | | | | | | |
| E (20) | N 6/12 | 350 | #2 | 20.45% | 0 | 0 | 0 | 0 | 0 | 0 | 0 | 0 | 0% |
| | | kGy | | | | | | | | | | | |
| F (20) | N 6/12 | 300 | #2 | 20.45% | 0 | 0 | 0 | 0 | 0 | 0 | 0 | 0 | 0% |
| | | kGy | | | | | | | | | | | |
| G (20) | N 6/12 | 250 | #2 | 20.45% | 0 | 0 | 0 | 0 | 0 | 0 | 1 | 0 | 5% |
| | | kGy | | | | | | | | | | | |
| H (20) | HDPE | 350 | #2 | 20.45% | 0 | 0 | 0 | 0 | 0 | 0 | 0 | 0 | 0% |
| | | kGy | | | | | | | | | | | |
| I (20) | HDPE | 300 | #2 | 20.45% | 0 | 0 | 0 | 0 | 0 | 0 | 0 | 0 | 0% |
| | | kGy | | | | | | | | | | | |
| J (20) | HDPE | 250 | #2 | 20.45% | 0 | 0 | 0 | 0 | 0 | 0 | 0 | 0 | 0% |
| | | kGy | | | | | | | | | | | |

### Example E

Cross-linked samples comprising irradiated, cross-linked HDPE and irradiated, cross-linked Nylon 12 were analyzed to determine gel content.

Specifically, a 0.5 g sample of the irradiated, cross-linked HDPE material was weighed and placed into a jar. 100 mL of xylenes was added and the jar was capped and suspended in an oil bath at 110° C. for 24 hours. The samples were cooled, dried under vacuum, and weighed. The cross-linked HDPE samples were determined to contain about 97% gel (i.e., about 97% of the mass did not dissolve under these conditions). Xylenes was selected as the solvent because non-cross-linked HDPE will almost completely dissolve in xylenes at such elevated temperatures.

Similarly, a 0.5 g sample of the irradiated, cross-linked Nylon 12 material was weighed and placed into ajar. 100 mL of 1,1,1,3,3,3-hexafluoro-2-propanol (HFIP) was added and the sample was immersed in HFIP for 24 hours. The samples were dried under vacuum and weighed. The cross-linked Nylon 12 samples were determined to contain about 94% gel (i.e., about 94% of the mass did not dissolve under these conditions). HFIP was selected as the solvent because non-cross-linked Nylon 12 will almost completely dissolve in HFIP under these conditions.

While some improvement in tensile strength was expected in the irradiated seals, the magnitude of improvement in reduction in leakage was surprising and unexpected particularly because of the increased rigidity of the seal material.

The foregoing results demonstrate that the disclosed seal assemblies advantageously reduce electrolyte creepage between the grommet and the nail, thereby extending the useful life of the seal assembly of a battery cell, particularly an alkaline battery cell.

The dimensions and values disclosed herein are not to be understood as being strictly limited to the exact numerical values recited. Instead, unless otherwise specified, each such dimension is intended to mean both the recited value and a functionally equivalent range surrounding that value, so as to encompass conventional manufacturing tolerances.

Every document cited herein, including any cross referenced patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A seal assembly for a battery cell, the seal assembly comprising:
a cross-linked grommet having an opening and comprising a cross-linked polymer; and
a current collector having a head and a stem extending from the head disposed in the opening, the stem and the cross-linked grommet forming an interference fit at the opening.

2. (canceled)

3. The seal assembly of claim 1, wherein the current collector comprises a brass alloy or a bronze alloy.

4. The seal assembly of claim 1, wherein the cross-linked polymer comprises a radiation-induced, cross-linked nylon.

5. The seal assembly of claim 4, wherein the radiation-induced, cross-linked nylon comprises one or more radiation-induced, cross-linked nylons chosen from cross-linked Nylon 10/20s, radiation-induced, cross-linked Nylon 12s, radiation-induced, cross-linked Nylon 11s, radiation-induced, cross-linked Nylon 10/12s, radiation-induced, cross-linked Nylon 6/12s, radiation-induced, cross-linked Nylon 6/10s, radiation-induced, cross-linked Nylon 4/12s, and radiation-induced, cross-linked Nylon 4/10s.

6. The seal assembly of claim 1, wherein the cross-linked polymer comprises one or more cross-linked polymers chosen from cross-linked Nylon 6s, cross-linked Nylon 6/6s, cross-linked Nylon 4/6s, cross-linked Nylon 3s, cross-linked Nylon 12s, cross-linked Nylon 11s, cross-linked Nylon 6/12s, cross-linked Nylon 10/20s, cross-linked Nylon 10/12s, cross-linked Nylon 6/10s, cross-linked Nylon 4/12s, cross-linked Nylon 4/10s, cross-linked ultra-high-density polyethylenes (UHDPEs), cross-linked low-density polyethylenes (LDPEs), cross-linked high-density polyethylenes (HDPEs), cross-linked atactic polypropylenes (PPs), cross-linked isotactic PPs, cross-linked polyvinyl chlorides, cross-linked polypropylene oxides, cross-linked polyvinyl acetates, cross-linked polybutadienes, cross-linked polystyrenes, cross-linked polymethyl acrylates, and cross-linked polymethyl methacrylates.

7. The seal assembly of claim 1, wherein the cross-linked polymer comprises one or more cross-linked polymers chosen from cross-linked HDPEs, cross-linked LDPEs, cross-linked atactic PPs, cross-linked isotactic PPs, cross-linked polyvinyl chlorides, cross-linked polybutadienes, cross-linked polystyrenes, cross-linked Nylon 12s, cross-linked Nylon 11s, and cross-linked Nylon 6/12s.

8. The seal assembly of claim 1, wherein the cross-linked polymer comprises a radiation-induced, cross-linked polymer and wherein the radiation-induced, cross-linked polymer is prepared by a process comprising exposing a pre-formed grommet comprising a precursor polymer material to one or more types of radiation chosen from electron beam radiation and gamma ray radiation.

9. The seal assembly of claim 8, wherein the radiation dose is at least 40 kGy.

10. The seal assembly of claim 1, wherein the cross-linked polymer is prepared by a process comprising reacting a cross-linking agent with a precursor polymeric material.

11. The seal assembly of claim 1, wherein an engagement interference between the cross-linked grommet and the current collector is greater than 15%.

12. The seal assembly of claim 1, wherein a gel content of the cross-linked polymer is greater than 50%.

13. A battery cell comprising;
a housing including a first cover at a first housing end and a second cover at a second housing end, and an anode and a cathode disposed within the housing; and
a seal assembly proximate the first cover, the seal assembly including a current collector having a head and a stem extending from the head, and a cross-linked grommet having an opening and comprising a cross-linked polymer, the stem extending through the opening and forming an interference fit with the grommet.

14. The battery cell of claim 13, wherein the cross-linked grommet is an irradiated, cross-linked grommet and the cross-linked polymer comprises a radiation-induced, cross-linked nylon.

15. The battery cell of claim 13, wherein the cross-linked grommet comprises a short boss or a long boss.

16. The battery cell of claim 13, further comprising an alkaline electrolyte.

17. The battery cell of claim 13, wherein an engagement interference between the cross-linked grommet and the current collector is greater than 15%.

18. The battery cell of claim 13, wherein a gel content of the cross-linked polymer is greater than 50%.

19. A method of manufacturing a battery cell with a cross-linked grommet, the method comprising:
forming a grommet comprising a precursor polymer material, thereby forming a pre-formed grommet;
exposing the pre-formed grommet comprising the precursor polymer material to a cross-linking treatment, thereby forming a cross-linked grommet; and
incorporating the cross-linked grommet in a battery cell.

20. The method of claim 19, wherein the cross-linking treatment comprises exposing the grommet to radiation, thereby creating an irradiated, cross-linked grommet.

21. The method of claim 20, wherein the radiation comprises one or more radiation types chosen from electron beam radiation and gamma ray radiation.

22. The method of claim 21, wherein the radiation is electron beam radiation and a dose of the electron beam radiation reaches at least 40 kGy.

23. The seal assembly of claim 1, wherein the cross-linked grommet comprises a polymer having an oxygen atom content as a percentage of non-hydrogen atoms content of less than 12%.

24. The method of claim 19, wherein the precursor polymer material further comprises one or more cross-linking agents.

25. The method of claim 24, wherein the chemical cross-linking agent comprises one or more cross-linking agents chosen from peroxide cross-linking agents, silane cross-linking agents, bis(maleimide) cross-linking agents, triallylcyanurate, triallylisocyanurate, trimethylolpropane triacrylate, and trimethylolpropane trimethacrylate.

26.-32. (canceled)
